(19) United States
(12) Patent Application Publication
(10) Pub. No.: US 2006/0006622 A1
(43) Pub. Date: Jan. 12, 2006

(54) Turning frame for skateboard

(75) Inventors: Daniel Gesmer, Hong Kong (CN); Kainin Andrew So, Hong Kong (CN)

Correspondence Address: ALIX YALE & RISTAS LLP, 750 MAIN STREET, SUITE 1400, HARTFORD, CT, 06103, US

(73) Assignee: DANIEL JON GES,ER KAININ ANDREW SO, HONG KONG SAR (CN)

(21) Appl. No.: 10/526,995

(22) PCT Filed: Sep. 5, 2003
(86) PCT No.: PCT/CN03/00753

§ 371 Date: Mar. 7, 2005

(30) Foreign Application Priority Data
Sep. 5, 2002 (HK) 0206540.0

(51) Int. Cl. B62M 1/00

(52) U.S. Cl. 280/87.042

(57) ABSTRACT

A skateboard truck includes a first base part having a first pair of mounting holes through each of which respective ones of a pair of fasteners can extend to secure the truck to a deck. There are second and third pairs of mounting holes, through either pair of which respective ones of a further pair of fasteners can extend to secure the truck to the deck. A second base part is secured to the first base part and including a bearing plate. A hanger bears against the bearing plate and is attached pivotally to the first base part by a pivot pin extending through the second base part. A pair of springs is mounted to the second base part to suspend the hanger.

### BACKGROUND OF THE INVENTION

The present invention relates to skateboard trucks. More particularly, although not exclusively, the invention relates to a skateboard truck having a base of two-part construction and having optional-use mounting holes by which the base can be attached to a skateboard deck.

Known skateboard trucks include a base fabricated from a single piece of material—usually cast aluminium, or possibly titanium or an aluminium alloy. The base serves as the means by which the truck is secured to the skateboard deck by bolts and to pivotally suspend a hanger to which the ground-engaging wheels are rotatably mounted.

There are two widely adopted truck mounting-bolt layouts used by skateboard manufacturers and truck manufacturers alike. In both systems, the bolts and corresponding mounting holes define corners of a rectangle. The “Old School” pattern has the bolts and mounting holes spaced further apart (in the length-wise direction of the skateboard) than the “New School” pattern.

It would be desirable to provide a skateboard truck having mounting holes positioned to accommodate either four-hole system. However, the base in the present invention must provide a large bearing surface against which the hanger can pivot in use as the rider steers the skateboard by tilting its deck. In designing a truck base having such a broad flat bearing surface it has been found that a one-piece construction does not lend itself to manufacturing by casting with a simple two-part mould, because an undercut would be necessary beneath the bearing surface in order to provide access to an innermost pair of mounting holes (a pair of mounting holes needed for the “New School” system).

Another problem of known skateboard trucks is associated with dampening the pivotal movement of the hanger with respect to the base. While metal springs have been used to optimise return-to-centre forces, dampening has been limited to that provided inherently by the rubber or plastic bushings associated with known hanger-mounting arrangements.

An additional problem of known skateboard trucks is that impact forces tend to loosen the wheel axles inside the hangers.

A further problem of known skateboard trucks is associated with appropriately matching steering geometry (the ratio between the skateboard deck's degree of lateral tilt and the trucks' steering response) with the skateboarder's forward velocity, such that the skateboard steers more rapidly at lower speeds and less rapidly at higher speeds.

### OBJECTS OF THE INVENTION

It is an object of the present invention to overcome or substantially ameliorate at least one of the above disadvantages and/or more generally to provide an improved skateboard truck.

### DISCLOSURE OF THE INVENTION

There is disclosed herein a skateboard truck comprising:
a first base part having a first pair of mounting holes through each of which respective ones of a pair of fasteners can extend to secure the truck to a deck, and second and third pairs of mounting holes, through either pair of which respective ones of a further pair of fasteners can extend to secure the truck to the deck,
a second base part secured to the first base part and including an integral bearing plate,
a hanger bearing against the bearing plate and attached pivotally to the first base part by a pivot pin extending through the second base part, and
a pair of springs mounted to the second base part and attached to the hanger.

Preferably the second and third mounting holes are positioned at one of two fastener-access cavities formed in the first base part.

Preferably the bearing plate of the second base part extends at least partly over the fastener-access cavities.

Preferably the pivot pin passes through a bushing.

Preferably the first and second base parts are cast/moulded from different materials.

Preferably an adjustment mechanism adjusts pre-load in the springs.

Preferably the adjustment mechanism includes an adjustment screw and nut between each spring and the hanger.

Preferably the springs comprise primary coil springs.

Preferably supplementary coil springs are located within the primary coil springs.

Preferably end portions of the supplementary springs, and at least one end portion of each primary coil spring, are housed by a spring cap sleeve.

Alternatively, the spring cap sleeves can move in and out of one another like a telescope during spring compression and decompression.

Alternatively, the springs can be resilient plastics mouldings.

Where the springs are resilient plastics mouldings, they can have barrel shapes, non-circular cross-sections and side cut-outs.

Preferably, the hanger includes a co-linear axle assembly formed of the same or similar material as that from which the hanger is fabricated, and includes strengthening inserts formed of a stronger material.

Preferably, the axle assembly includes an irregularity in its midsection—such as a bend, flattened portion or set of ridges or rings—that discourages it from stripping or spinning inside the hanger.

Preferably the hanger is formed from aluminium or other strong, lightweight material such as titanium.

Preferably the axle inserts are steel or other high-strength material.

Preferably the second base part is formed of moulded plastics material.

Preferably the moulded plastics material is chosen to provide good lubricity between the bearing plate and the hanger and a small degree of flexibility at outer edges of the bearing plate.

Preferably the first base part includes a mounting surface that is tightened against a deck by fasteners passing through the holes.

Preferably the bearing plate extends at an acute angle with respect to the mounting surface and the pivot pin extends normally to the bearing plate.

Preferably the second base part includes a pair of holes aligned with the first pair of holes of the first base part and the first pair of fasteners extend through the aligned holes and assist in securing the first base part to the second base part.

Preferably the pivot pin has a threaded end that is protected and fastened within a recess of the first base part, so as not only to pull the hanger against the bearing plate but also to assist in securing the first base part to the second base part.

### BRIEF DESCRIPTION OF THE DRAWINGS

A preferred form of the present invention will now be described by way of example with reference to the accompanying drawings, wherein:

FIG. 1 is a schematic parts-exploded perspective illustration of a skateboard truck,

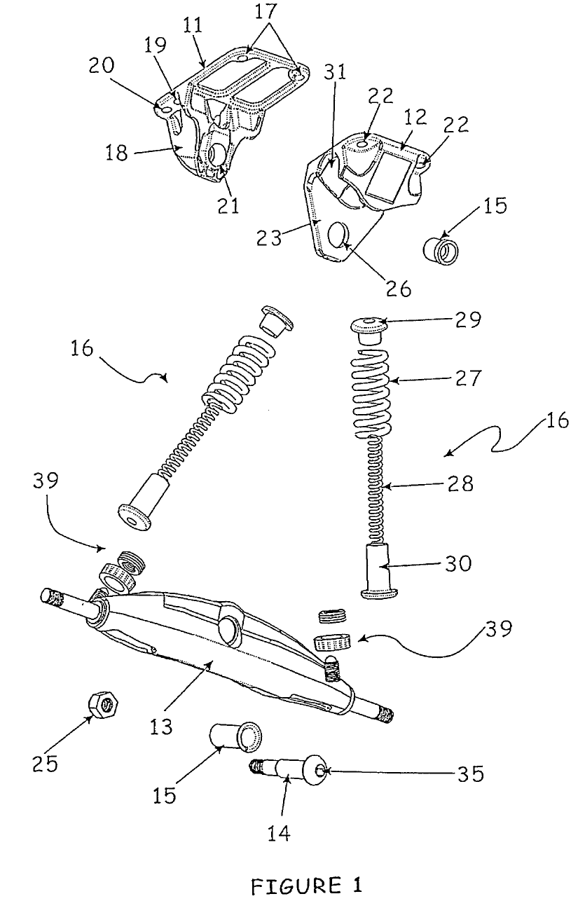

FIG. 2 is a schematic perspective illustration of the assembled truck, viewed from below, and

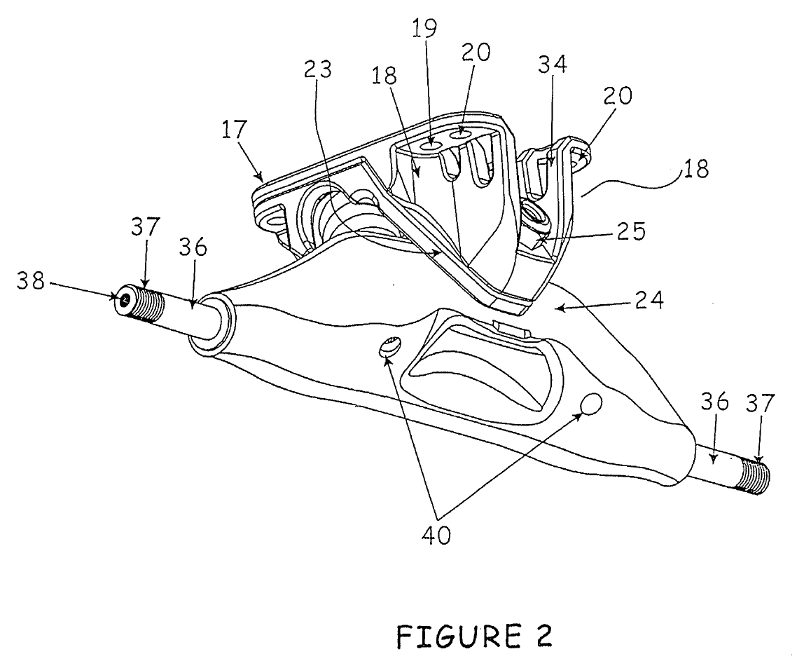

FIG. 3 is a schematic perspective illustration of the assembled truck, viewed from above.

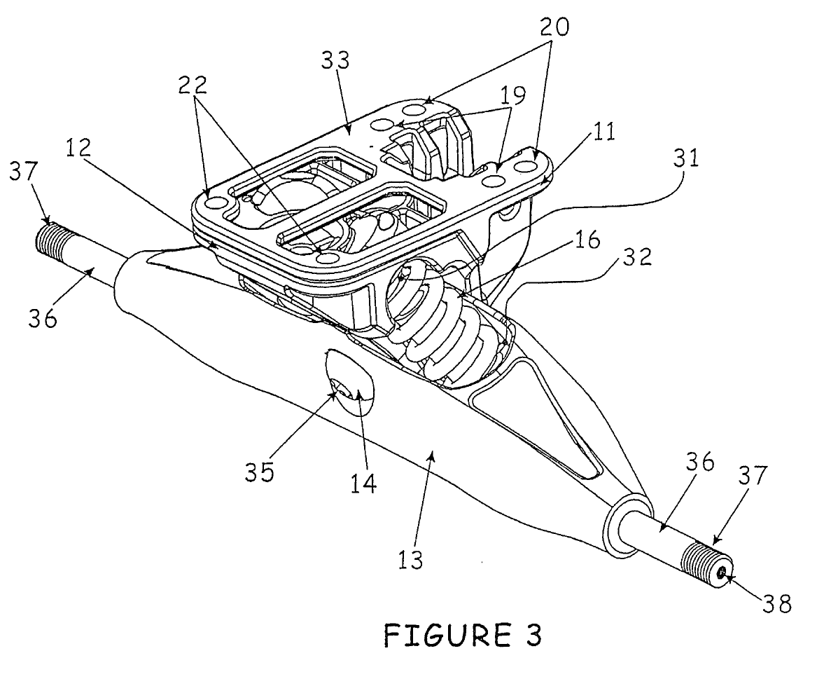

### DESCRIPTION OF THE PREFERRED EMBODIMENT

In the accompanying drawings there is schematically depicted a skateboard truck 10. Truck 10 comprises a first (or upper) base part 11 that is typically formed as a casting, for example of aluminium, titanium, an aluminium alloy, or magnesium alloy for example. The truck 10 also includes a second (or lower) base part 12 typically formed as a moulding of plastics material. The plastics material might be nylon, high-density polyethylene, or other plastics material displaying high toughness and having good surface-lubricity.

A hanger 13 is attached pivotally to the two base parts 11 and 12 by a pivot pin 14 that passes through a bushing 15.

A pair of spring assemblies 16 suspend the hanger 13.

The upper base part 11 includes a first pair of holes 17. At the opposite end of the upper base part 11 there is a pair of fastener-access cavities 17, each having one of a second pair of holes 19 and one of a third pair of holes 20.

The upper base part 11 also includes an aperture 21 through which the pivot pin 14 passes to pivotally secure the hanger 13 thereto.

Whereas the first pair of apertures 17 is always used to secure the skateboard truck 10 to a skateboard deck, typically only one of the second 19, or third 20 pairs of apertures are used, depending upon whether the interior “New School” four-hole system or exterior “Old School” four-hole system is used.

The lower base part 12 includes a pair of apertures 22 that align with the first pair of apertures 17 of the upper base part. The fasteners passing through the first pair of apertures 17 also pass through apertures 22. These fasteners serve not only to secure the truck 10 to the skateboard deck, but also serve to secure the lower base part 12 to the upper base part 11.

The lower base part 12 includes a flat bearing plate 23 against which a flat surface 24 of the hanger 13 bears. The bearing plate 23 extends at an acute angle with respect to the mounting surface 33 of the upper base part 11 when assembled.

A nut 25 is tightened upon a threaded portion of the pivot pin 14. This fastening not only pulls the hanger 13 against the bearing plate 23, but also serves to secure the lower base part 12 to the upper base part 11.

As the hanger 13 pivots about the pivot pin 14 in use, the flat surface 24 twists against the bearing plate 23 and it is between these surfaces that there ought to be a good degree of lubricity. Appropriate choice of plastics material in the lower base part 12 provides this characteristic. Appropriate choice of plastics material in the lower base part 12 also permits the outer edges of the bearing plate 23 to flex slightly under the added pressures of sharp turns at higher speeds, thereby reducing the steering articulation of the hanger 13 and providing greater stability precisely when it is needed. The nut 25 is received within a nut recess 34 of the upper base part 11. The other end of the pivot pin 14 has an Allan key recess 35.

In the centre region of the bearing plate 23 there is an aperture 26 that aligns with aperture 21. The bushing 15 passes through the aperture 26 when inserted into the aperture 21.

Each spring assembly 16 includes an outer coil spring 27 and an inner coil spring 28. Inserted into one end of both the outer coil spring 27 and the inner coil spring 28 is a cap 29. The other end of inner coil spring 28 is received within an end cap sleeve 30. The caps 29 and 30 are typically formed of lubricious moulded plastics material so that neither of the springs audibly catch or scrape against them during compression and decompression.

The outer springs 27 may alternatively be formed of a plastics material such as urethane having greater dampening properties than helical coil springs, thereby enhancing performance for certain skateboard uses such as, for example, downhill racing. In this case, the spring elements may have barrel shapes, non-circular cross-sections and side cut-outs to optimise steering control.

The spring caps 29 and 30 may also be formed with longer sleeves that move in and out of one another like a telescope during spring compression and decompression, thereby constraining the spring elements to compress along a substantially linear axis.

Each spring assembly 16 has one end received within a spring cavity 31 of the lower base part 12, and its other end received within a spring cavity 32 of the hanger 13. The respective longitudinal axes of the two spring assemblies 16 are acutely angled with respect to one another.

In order to adjust the “tightness” of the steering response, a system of spring pre-loading nuts 39 and screws is provided. An Allan key passing through small apertures 40 in the hanger can turn the screws.

The hanger 13 includes a co-linear axle assembly 36, having on each end a threaded portion 37 to receive a locknut by which wheels are fastened. The axle assembly can be cast integrally with the hanger and can therefore be formed of the same or similar material as the hanger, typically aluminium, titanium, aluminium alloy, or magnesium alloy for example. To provide increased strength to the axle assembly, high-strength insert rods 38 can extend through the axle assembly and into the main body portion of the hanger. There might be just one continuous insert rod 38 extending throughout the entire axle assembly. Alternatively, there might be two separate insert rods 38 extending part way into each end of the hanger body. The insert rods are typically formed from high-strength spring steel for example.

The axle assembly can additionally include an irregularity in its midsection—such as a bend, flattened portion or set of ridges or rings—that discourages it from stripping or spinning inside the hanger.

It should be appreciated that modifications and alterations obvious to those skilled in the art of skateboard truck design, manufacture and use, should not be considered as beyond the scope of the present invention. For example, the angle at which the bearing plate 23 extends from the mounting surface 33, whilst being important to riding dynamics, is not important to the present invention and can be other than what is shown in the drawings without departing from the scope of the invention.

1. A skateboard truck comprising:
a first base part having a first pair of mounting holes through each of which respective ones of a pair of fasteners can extend to secure the truck to a deck, and second and third pairs of mounting holes, through either pair of which respective ones of a further pair of fasteners can extend to secure the truck to the deck,
a second base part secured to the first base part and including an integral bearing plate,
a hanger bearing against the bearing plate and attached pivotally to the first base part by a pivot pin extending through the second base part, and
a pair of springs mounted to the second base part and attached to the hanger.

2. The skateboard truck of claim 1 wherein the second and third mounting holes are positioned at one of two fastener-access cavities formed in the first base part.

3. The skateboard truck of claim 2 wherein the bearing plate of the second base part extends at least partly over the fastener-access cavities at the rear of the first base part.

4. The skateboard truck of claim 1 wherein the pivot pin passes through a bushing.

5. The skateboard truck of claim 1 wherein the first and second base parts are cast/moulded from different materials.

6. The skateboard truck of claim 1 wherein an adjustment mechanism adjusts pre-load in the springs.

7. The skateboard truck of claim 6 wherein the adjustment mechanism includes an adjustment screw and nut between each spring and the hanger.

8. The skateboard truck of claim 1 wherein the springs comprise primary coil springs.

9. The skateboard truck of claim 8 wherein supplementary coil springs are located within the primary coil springs.

10. The skateboard truck of claim 9 wherein end portions of each supplementary spring, and at least one end portion of each primary coil spring, are housed by a spring cap sleeve.

11. The skateboard truck of claim 1 wherein the springs are resilient plastics mouldings.

12. The skateboard truck of claim 10 wherein the spring cap sleeves move in and out of one another like a telescope during spring compression and decompression.

13. The skateboard truck of claim 11 wherein the springs have barrel shapes, non-circular cross-sections and side cut-outs.

14. The skateboard truck of claim 1 wherein the hanger includes a co-linear axle assembly formed of the same or similar material as that from which the hanger is fabricated, and includes strengthening inserts formed of a stronger material.

15. The skateboard truck of claim 14 wherein the axle assembly includes an irregularity in its midsection.

16. The skateboard truck of claim 1 wherein the hanger is formed from aluminium, titanium or other strong, lightweight material.

17. The skateboard truck of claim 14 wherein the axle inserts are steel or other high-strength material.

18. The skateboard truck of claim 1 wherein the second base part is formed of moulded plastics material.

19. The skateboard truck of claim 18 wherein the moulded plastics material is chosen to provide good lubricity between the bearing plate and the hanger and a small degree of flexibility at outer edges of the bearing plate.

20. The skateboard truck of claim 1 wherein the first base part includes a mounting surface that is tightened against a deck by fasteners passing through the holes.

21. The skateboard truck of claim 20 wherein the bearing plate extends at an acute angle with respect to the mounting surface and the pivot pin extends normally to the bearing plate.

22. The skateboard truck of claim 1 wherein the second base part includes a pair of holes aligned with the first pair of holes of the first base part and the first pair of fasteners extends through the aligned holes and assist in securing the first base part to the second base part.

23. The skateboard truck of claim 1 wherein the pivot pin has a threaded end that is protected and fastened within a recess of the first base part, so as not only to pull the hanger against the bearing plate but also to assist in securing the first base part to the second base part.
